(19) United States
(12) Patent Application Publication
(10) Pub. No.: US 2020/0022306 A1
(43) Pub. Date: Jan. 23, 2020

(54) MOWER APPARATUS

(71) Applicant: Robin MEYER, Tonbridge (GB)

(72) Inventor: Robin MEYER, Tonbridge (GB)

(21) Appl. No.: 16/338,079

(22) PCT Filed: Sep. 29, 2017
(86) PCT No.: PCT/EP17/74906

§ 371 Date: Mar. 29, 2019

(30) Foreign Application Priority Data
Sep. 30, 2016 (GB) 1616659.7

(51) Int. Cl. A01D 43/02; A01D 34/68

(52) U.S. Cl. CPC A01D 43/02; A01D 2101/00; A01D 34/68

(57) ABSTRACT

The present invention concerns support apparatus for a mowing device, the support apparatus comprising: a front roller mechanism having one or more rollers for supporting a front region of the mowing device, the one or more rollers having a cylindrical contact surface whose longitudinal extent is configured for extending across at least 60% of the front region of the mowing device.

The present invention relates to a mower apparatus, or support apparatus, for example for the front end of a mowing device, and in particular to a support apparatus for use with a mowing device for the purpose of avoiding tram-lines during mowing.

Increasing focus on garden maintenance is prevalent as more societies acquire leisure time. Garden maintenance often involves at a basic level, maintenance of a lawn. Before the middle of the 20th century, lawn mowers were mostly reel mowers with a cylindrical blade that derived its power from the person pushing it.

A new type of lawn mower emerged after World War II, with the development of suburban housing and the larger lots that came with it. As small engines became more powerful, a new type of lawn mower that could cut larger and longer swaths of grass became more popular. Instead of cutting grass like scissors cut paper as a reel mower does, the rotary mower spins a horizontal blade around fast enough to cut the grass. The blade sits within a casing called a deck, which keeps the grass and other objects from flying in all directions when struck. Typically, the deck rides on four wheels, with a motor sitting on top of it and a bag attached to it to collect the cut grass.

Cylinder mowers are much heavier than the average rotary mower, therefore this must be taken into consideration when operating and storing.

Rotary mowers and cylinder mowers can give a nice clean finish when a rear roller is used. Cylinder mowers are used on bowling greens and golf greens because of the effectiveness to achieve short cut. However, in view of the weight distribution of rotary mowers, their front wheels create undesirable twin tram lines, which can look unsightly and damage the grass.

From European patent application EP 0 552 000 (HOWELLS) a rotary type mowing apparatus is known which in use is supported above the ground or other reaction surface by means of a cushion of air generated by a rotary impeller, includes wheels and/or rollers mounted on axles which are displaceable between a lowered ground-engaging position and a retracted position, whereby the user can choose between use of the apparatus with the wheels or rollers in contact with the ground or, alternatively, in the hover mode. As is typical with mowers of this type, the wheels at the front of the mowing apparatus are placed at the corners of the apparatus, at the periphery of its cutting path. Conventional thinking is to place the front wheels there to avoid compressing the grass that is about to be cut.

U.S. Pat. No. 3,755,998 (HOFFMEYER) discloses an adjustable lawn mower roller support for use with a rear roller arrangement for the mower. The mower also has a pair of small narrow front rollers positioned right at the edges of the cutting path of the mower, so that they impinge to a minimal extent on the cutting path as the mower moves forward. Again the rollers are placed to avoid compressing grass that is about to enter the cutting path of the mower.

With mowing devices of this nature, the front wheels create problematic twin tram lines as the device is moved forward. As a consequence of being at the peripheral edges of the mowing device, such lines are often accentuated because they are used as guide lines for an adjacent cutting path on a return run.

An object of the invention is therefore to alleviate the problem of the creation of such tram lines.

According to the present invention there is provided support apparatus for a rotary mowing device, the support apparatus comprising: a front roller mechanism having one or more rollers for supporting a front region of the mowing device; a deck which supports a drive means for activating a rotary cutting blade and which shrouds the at least one cutting blade that in use is driven by the drive means so as to cut a path; and wherein the one or more rollers of the front roller mechanism are arranged outside of the deck, the one or more rollers having a cylindrical contact surface whose longitudinal extent is configured for extending across at least 60% of the front region of the mowing device. In this way, the roller or rollers spread the weight at the front of the mower device or the like across their length so as to prevent track marks or tram lines being left in the lawn, thereby promoting an even finish and avoiding damage to the lawn. An advantage of the one or more rollers of the front roller mechanism being arranged outside of the deck or housing is that the updraft inside the mower deck (i.e. the housing which shrouds the at least one cutting blade) is increased, allowing for less interference of rotary circulation. As such, grass blades are lifted more readily, improving the cutting effectiveness of the rotary mowing device. A further advantage is that cut grass, stones, debris or the like, clog around parts proximal to the cutting blade. Clogging not only leads to failure of moving parts, and increased maintenance costs, but also results in accelerated rusting of the housing (e.g. for example, by the action of wet grass) when the device is stored after use.

The one or more rollers hence extend in advance of and across a cutting path of the mowing device.

Preferably, the longitudinal extent of the cylindrical contact surface of the one or more rollers is configured for extending across at least 80% of the front region of the mowing device. More preferably, the longitudinal extent of the one or more rollers is configured for extending across at substantially the entire width of the front of the mowing device. Contrary to conventional wisdom, any compressive effect on the grass by the rollers is more than accommodated for by the sucking of air into the deck on rotation of the blade. Such a suction effect acts to draw the grass blades into a more upright orientation ready for cutting.

Conveniently, the one or more rollers comprise a single roller. A single roller is generally speaking easier to manufacture and creates a more sealed deck, promoting enhanced suction for pulling air through the grass about to be cut.

Preferably, the one or more rollers comprise two rollers, each having a longitudinal extent that is configured for extending across at least 30% of the front region of the mowing device.

Conveniently, the one or more rollers comprise three rollers, each having a longitudinal extent that is configured for extending across at least 20% of the front region of the mowing device.

Preferably, the one or more rollers are arranged to comprise indentations in the cylindrical contact surface. Such indentations can be configured to enhance the air flow characteristics into the deck.

The support apparatus can further comprise a guide means, such as a comb for location rearwardly of the front roller mechanism. Preferably, the guide means has a plurality of vertical tines. The guide means acts to agitate and align the grass blades to promote their correct position for cutting.

Conveniently, the guide means is height and/or orientation adjustable for dealing with different conditions.

Conveniently, the front roller mechanism is height adjustable, again for dealing with different conditions, such as grass blade length and dryness.

Preferably, the deck further comprises a front annex having forward projecting side walls, a top face and a front face.

The front roller is mechanism is preferably coupled to the front annex.

Preferably, the apparatus is further provided together with a rear roller mechanism having one or more rollers for supporting a rear end of the mowing device, the one or more rollers having a cylindrical contact surface whose longitudinal extent is configured for extending across at least 60% of the front region of the mowing device.

Preferably, the mowing device comprises a pedestrian rotary mowing device.

The width of the front region of the mower may be substantially defined by the cutting path, so that preferably, the one or more rollers have a cylindrical contact surface whose longitudinal extent is configured for extending across at least 60% of the cutting path.

Preferably, the support apparatus further comprises a height adjustment apparatus to simultaneously adjust the height of the guide means and the one or more rollers of the front roller mechanism.

The housing may comprise a deck, and the housing may further comprise a bag, box or cuttings collector. The cutting blade may include a datum.

In some embodiments a plurality of cutting blades may be provided.

Preferably the moving device may include a handle so as to manoeuvre and steer the mowing device.

In some embodiments the mowing device is driven or steered manually.

In some embodiments the mowing device is self-driving, wherein the rear roller or front roller are powered by drive means so as to rotate. Typically the drive means includes a transmission that turns at least one roller using the power provided by the drive means.

The drive means may include but is not limited to a motor or an engine. For example the drive means may comprise an internal combustion engine, running on two or four cycles. Further embodiments may use electric motors powered by a cord, at least one battery, typically a rechargeable battery, or renewal energy means such as photovoltaic cells.

In this way the mowing device is capable of providing rolled lines on a lawn, wherein no indentations will be created by movement of the mowing device in use, and/or weight of the mowing device is dispersed across the rollers.

In some embodiments the rear roller may be subdivided into two or more semi-rollers, wherein the semi-rollers may be driven by a belt between the two or more semi-rollers or so as to house the gearbox.

In some embodiments the guide means is integrated with the housing. The guide means is arranged to agitate the lawn so as to aid with cutting the grass by presenting the grass so that it can be easily cut by the cutting blade. In some embodiments the guide means may be displaceable.

Preferably, the guide means is situated behind the front roller in use so as to agitate the grass after it has been rolled.

The guide means may comprise a comb with a series of tines, arranged to comb the lawn and consequently lift the grass so as to allow for the grass to be straightened to a substantially vertical arrangement that is better for the cutting blade in order to enable all grass to be cut to a similar length.

In some embodiments, the drive means is situated centrally on the housing, wherein the housing comprises a housing for the cutting blade, so as to allow the blades to rotate internally there-within, and provide a fixed arrangement of the rotating blades and housing sidewalls surrounding two sides, and housing top face above, with an open bottom face, allowing the blades to cut the grass. In some embodiments the blades may rotate on a plane approximately equal to a lowermost edge of the sidewalls, or housing.

In this way the centre of rotation is relatively low on the device, in the housing, and the weight of the drive means is dispersed across the housing.

The housing top face may be perforated so as to allow through-passage of a driveshaft, which driveshaft is driven by the drive means. In this way the housing spreads the weight of the drive means across the rollers,

In certain embodiments, the mowing device comprises a lawnmower, wherein the cutting blades are arranged to rotate horizontally, driven by a driveshaft. The lawnmower typically has multiple cutting blades that rotate on a horizontal plane about the vertical axis provided by the driveshaft.

The drive means may include a throttle in some embodiments, mounted on the handle, which keeps fuel flowing to the drive means. Advantageously so as to prevent injury, such drive means shuts off if the throttle is released. The throttle may allow for adjustment of the drive means speed.

In this way the front roller advantageously spreads weight of the drive means equally across the width of the mowing device.

The front elongate roller may be subdivided into a plurality of rollers such that the device is better enabled to turn in use. In some embodiments the front roller may be advantageously subdivided into peripheral semi-rollers, which may be wide enough to limit indentation from the weight of the device, but allow the rollers to be situated perimetrically from the cutting circle, so as to allow cutting between the front semi-rollers, and advantageously allow cutting across the footprint of the device.

At least one of the front or rear roller(s) and optionally both may be provided with height adjustment means, in order to advantageously allow for variation in cut height of the lawn. For example the housing is elevated from the roller so as to change the position of the cutting blade(s) relative to the lawn.

Such adjustment means may comprise vertically linear height adjustment in some embodiments so as to advantageously permit the device footprint to remain standardised.

Such adjustment means in other embodiments may comprise a pivoting means so as to allow for an easy and cost-effective adjustment, pivoting about a central hub or axle.

The guide may also include a height adjustment mechanism so as to allow for height adjustment relative to length of the lawn and/or type of grass. The height adjustment mechanism may comprise a vertically linear height adjustment so as to allow for incremental height adjustment in line with the height adjustment means of the roller(s).

In some embodiments the height adjustment means and mechanism may be combined in a single height adjustment apparatus, which apparatus may comprise a vertically linear height adjustment of at least the front roller(s) and guide. In some embodiments the apparatus may comprise adjustment of the front roller(s) and comb and rear roller(s); in other embodiments the height adjustment apparatus may comprise height adjustment of the front and rear roller(s) and the guide.

In some embodiments the front roller(s) is arranged so as to allow the user visibility of striping, wherein the user is enabled to see the front roller(s)' peripheral edges, and so align the front and rear rollers in use, and provide effective striping of the cut lawn.

The rollers enable the user to stripe the lawn even without the cutting blade in use. In some embodiments the front roller and a guide may be attached to an existing mower device, so as to create a dual roller apparatus.

In some embodiments, the cutting blade is designed to cut the grass clippings into tiny pieces that can be used in mulch. The deck on such embodiments contains the clippings until the mulching blade can shred them such that whether the clippings are mulched or not, they move through the deck into a side- or rear-mounted bag that collects them, or the mower returns them to the ground.

In further embodiments the device is self-propelled, wherein the drive means turns a drive means for example connected to a belt or chain that connects to a gearbox attached to an axle that spins, making the roller(s) move. Alternatively a drive shaft may be connected directly to the gearbox.

According to a further aspect of the present invention there is provided a rotary mower comprising: a deck supporting a drive means for activating a rotary cutting blade that is enclosed within the deck; a front roller that extends outside of and across the front of the deck for supporting a front region of the mower; and a rear roller for supporting a rear region of the mower.

Preferably, the rotary cutting blade defines a cutting path and wherein the front roller extends across at least 60% of the cutting path.

Conveniently, the front roller extends across the entirety of the cutting path.

An embodiment of the present invention will now be described by way of example and with reference to the accompanying drawings, of which:

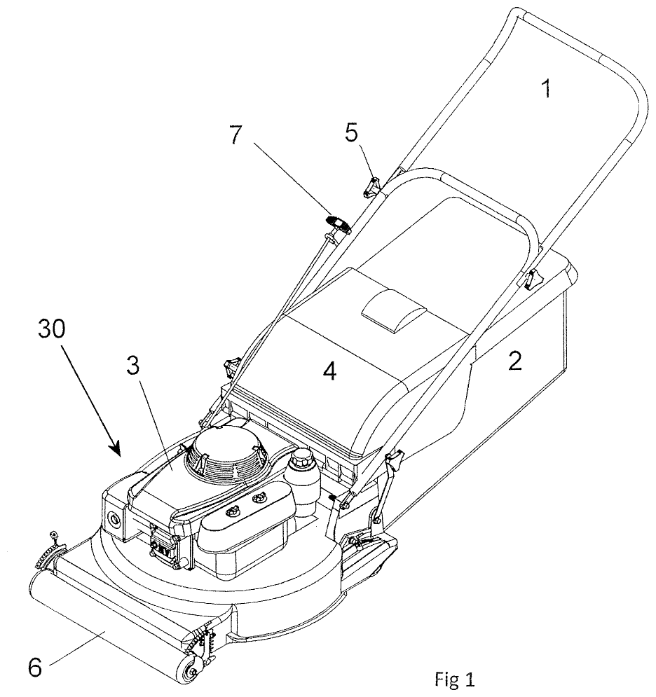

FIG. 1 shows an isometric view of an embodiment of the device according to the present invention;

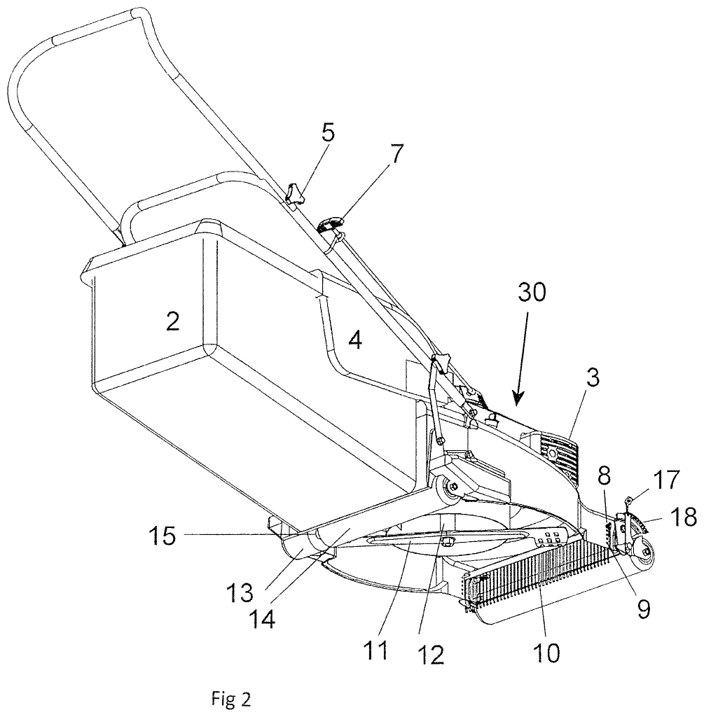

FIG. 2 shows a reverse isometric view of the embodiment shown in FIG. 1;

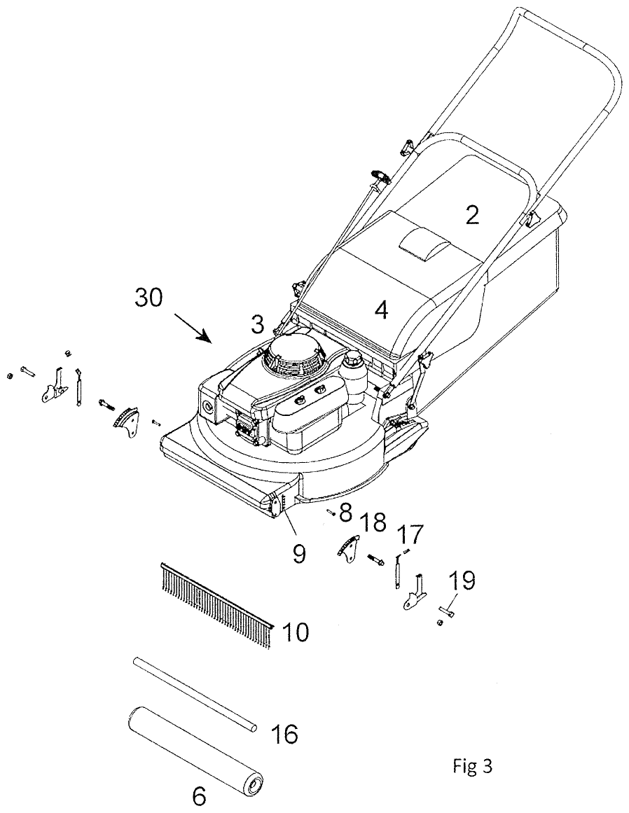

FIG. 3 shows an exploded isometric view of the embodiment shown in FIG. 1; and

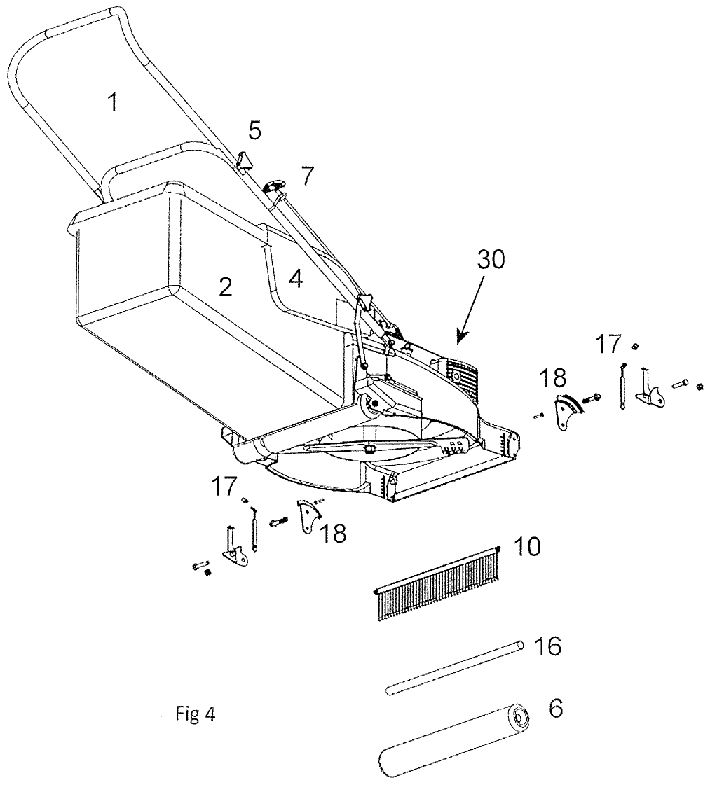

FIG. 4 shows a reverse exploded isometric view of the embodiment shown in FIG. 1.

With reference to the figures there is shown an embodiment of a mowing device, the device having a single front roller 6 arranged outside of a housing or deck 30. The uncovered front roller 6 acts as a visual guide for uniform lawn stripes.

The housing comprises a deck 30, supporting a drive means 3 and handle 1, and leading to a rearmost cuttings container 2.

The deck 30, is generally annular in shape and further comprises a skirt having side faces and an end edge. The skirt shields or shrouds the cutting blade around the side faces of the deck.

Attached to the side faces of the skirt, at front end of the mower, is a rectangular box-sectioned annex which houses the comb 10.

The annex comprises a rear concave opening whose curvature matches and aligns with the annular shape of the sides faces of the skirt around the front end of the mower.

Additionally, the annex comprises two forward projecting sides, a top face, and a front face. The annex is open at its rear and underside.

The underside and rear openings of the annex allow fluid communication between the annex and the inside of deck. The two sides, top and front faces provide rigidity, being formed of suitable material, e.g. steel, aluminium, plastics or the like.

The front roller or rollers 6 is/are secured to the forward projecting sides of the annex and extend across the front face of the annex.

The container 2 is removable and may be displaced to leave a hinged flap 4, which flap 4 is biased to close over an exit from the cutting blade (see FIGS. 2 and 4).

The handle may be folded for transport or storage, and can comprise friction adjustment wheels 5.

The front roller 6 has a central axle 16 which runs in front of a guide comprising an agitating comb 10, which comb promotes lifting of the grass to a consistent cut length.

The comb adjustment mechanism comprises a set of location holes on the side of the deck. The user can adjust the height of the comb by moving the sprung pin 8 into the desired location hole 9.

The front roller may also be provided with a height adjustment means, whereby a user can adjust the height of the roller by rotating the sprung catch 17 on a pivot 19, into the desired slot 18. Peripheral double adjustments for the comb and front roller prevent the rollers and comb from leaning to one side during use. The handles of each of the front height adjusters on the front adjustment means and the height adjusters on the adjustment mechanism roller may act as a visual guide for the user to consistently align the mower with the previous lawn stripe.

In the present embodiment, the front roller extends across the entire width of the front of the mower. In this connection, the front roller should extend across at least 60% of the front end of the mower to avoid the creation of undesirable tram lines. Whilst it has been conventional wisdom to avoid rollers at the front end due to the feeling that they would compress the grass about to be cut detrimentally, in fact the passage of air through the grass within the mower deck as the blade rotates is sufficient to lift grass that may have been compressed.

The guide, in the form of a comb, can be used to further promote the lifting of the grass in preparation for cutting.

Furthermore, the front roller may include indentations that allow passage of air there-through to draw air past the grass approaching the cutting path of the blade. Such indentations may be placed and configured to enhance the fluid flow into mower housing.

The cutting blade is centrally located below the drive means on the deck.

The rear roller sits behind the cutting blade. The rear roller is split into two semi-rollers 13, 14 so as to allow for variable turning speeds and allow a turning circle, as well as to permit location of a gearbox 15.

The drive means comprises a starter 7, and is an internal combustion engine, which runs on either two cycles or four, such that two-cycle motor embodiments burn a mixture of gasoline and oil, while four-cycle motor embodiments burn gasoline and have a separate lubrication system.

The drive means turns a vertical axle that's attached to a single large blade, which may be made of a single piece of steel, and lies suspended horizontally above the ground within the housing when the adjustment apparatus is set at a lowest height. The blade has a cutting height of approximately 13 mm to approximately 70 mm. The adjustment apparatus comprises the adjustment mechanism and the adjustment means.

The blade spins at substantially 3,000 revolutions per minute and slices the grass as it passes over it. In some embodiments the blade can be either straight or curved.

As the blade spins it define a cutting path as the mower moves forward. In general, the cutting path has substantially the same width as the one or more rollers.

The width of the front region of the mower can be substantially defined by the cutting path, so that preferably, the one or more rollers have a cylindrical contact surface whose longitudinal extent is configured for extending across at least 60% of the cutting path.

The invention has been described by way of examples only and it will be appreciated that variation may be made to the above-mentioned embodiments without departing from the scope of invention as defined by the claims.

1-25. (canceled)

26. A support apparatus for a rotary mowing device, the support apparatus comprising:
a front roller mechanism having one or more rollers for supporting a front region of a mowing device;
a deck which supports a drive means for activating a rotary cutting blade and which shrouds the at least one cutting blade that in use is driven by the drive means so as to cut a path; and
wherein the one or more rollers of the front roller mechanism are arranged outside of the deck, the one or more rollers having a cylindrical contact surface whose longitudinal extent is configured for extending across at least 60% of the front region of the mowing device.

27. The support apparatus according to claim 26, wherein the longitudinal extent of the one or more rollers is configured for extending across at substantially the entire width of the front of the mowing device.

28. The support apparatus according to claim 26, wherein the one or more rollers comprise two rollers, each having a longitudinal extent that is configured for extending across at least 30% of the front region of the mowing device.

29. The support apparatus according to claim 26, wherein the one or more rollers comprise three rollers, each having a longitudinal extent that is configured for extending across at least 20% of the front region of the mowing device.

30. The support apparatus according to claim 26, wherein the one or more rollers are arranged to comprise indentations in the cylindrical contact surface.

31. The support apparatus according to claim 26, further comprising a guide means for location rearwardly of the front roller mechanism for lifting grass blades.

32. The support apparatus according to claim 31, wherein the guide means comprises a comb having a plurality of vertical tines.

33. The support apparatus according to claim 31, wherein the guide means is height adjustable.

34. Support apparatus according to claims 31, wherein the guide means is orientation adjustable.

35. The support apparatus according to claim 26, wherein the front roller mechanism is height adjustable.

36. The support apparatus according to claim 26, further provided together with a rear roller mechanism having one or more rollers for supporting a rear end of the mowing device, the one or more rollers having a cylindrical contact surface whose longitudinal extent is configured for extending across at least 60% of the front region of the mowing device.

37. The support apparatus according to claim 26, wherein the mowing device comprises a pedestrian rotary mowing device.

38. The support apparatus according to claim 31, further comprising a height adjustment apparatus to simultaneously adjust the height of the guide means and the one or more rollers of the front roller mechanism.

39. A rotary mower comprising:
a front roller mechanism having one or more rollers for supporting a front region of a mowing device;
a rotary cutting blade for cutting grass in a cutting region of the mowing device; and
a guide, positioned rearwardly of the one or more rollers, for lifting grass blades about to enter the cutting region.

40. A rotary mower comprising:
a deck supporting a drive means for activating a rotary cutting blade that is enclosed within a deck;
a front roller that extends outside of and across the front of the deck for supporting a front region of a mower; and
a rear roller for supporting a rear region of the mower.

41. The rotary mower according to claim 40, wherein the rotary cutting blade defines a cutting path and wherein the front roller extends across at least 60% of the cutting path.

42. The rotary mower according to claim 40, further comprising a guide, positioned between the front roller and the rotary cutting blade, for lifting grass blades about to enter a cutting region of the lawn mower.

43. The rotary mower according to claim 40, further comprising a rear-mounted bag that collects grass clippings.
